(19) United States
(12) Patent Application Publication
(10) Pub. No.: US 2021/0289303 A1
(43) Pub. Date: Sep. 16, 2021

(54) MONITORING APPARATUS AND MONITORING METHOD

(71) Applicant: JTEKT CORPORATION, Osaka (JP)

(72) Inventors: Boyko STOIMENOV, Kashiba-shi (JP); Mikio NOZAKI, Kashihara-shi (JP)

(73) Assignee: JTEKT CORPORATION, Osaka (JP)

(21) Appl. No.: 17/193,209

(22) Filed: Mar. 5, 2021

(30) Foreign Application Priority Data
Mar. 10, 2020 (JP) 2020-041113

(51) Int. Cl. H04R 29/00; H04R 3/00; H04R 1/32

(52) U.S. Cl. CPC H04R 29/005; H04R 1/326; H04R 3/005

(57) ABSTRACT

A monitoring apparatus includes a sound collecting device and an information processing device. The sound collecting device has a plurality of microphones arranged. The microphones convert sound waves emitted from the target regions into sound pressure signals respectively. The information processing device stores map information on positions of the target regions with respect to the sound collecting device, and extracts a specific sound pressure signal from the sound pressure signals for each of the target regions by subjecting the sound pressure signals to beam forming processing based on the map information.

### CROSS-REFERENCE TO RELATED APPLICATION

This application claims priority to Japanese Patent Application No. 2020-041113 filed on Mar. 10, 2020, incorporated herein by reference in its entirety.

### BACKGROUND

### 1. Technical Field

The disclosure relates to a monitoring apparatus and a monitoring method for monitoring a plurality of target regions.

### 2. Description of Related Art

There is known an art of making a diagnosis of abnormality in an instrument based on a sound produced from the instrument. For example, Japanese Unexamined Patent Application Publication No. 2013-200144 (JP 2013-200144 A) discloses an art of subjecting a signal from a sound collector to various kinds of processing such as fast Fourier transformation to learn and diagnose a sample value. Japanese Unexamined Patent Application Publication No. 2001-151330 (JP 2001-151330 A) discloses an art that relates to a belt conveyor abnormality diagnosis device and that uses an omnidirectional microphone and a directional microphone.

Besides, Japanese Unexamined Patent Application Publication No. 2017-32488 (JP 2017-32488 A) discloses an art of specifying a two-dimensional position of a sound source that has produced an abnormal sound through the use of a microphone array having sound collecting elements arranged in a two-dimensional manner. In JP 2017-32488 A, the position of the sound source that has produced the abnormal sound is specified based on the sound collecting element where the abnormal sound arrived at the earliest timing or the sound collecting element that has most clearly detected the abnormal sound. Then, an instrument unit of the sound source that has produced the abnormal sound is specified based on an instrument map on planar arrangement of instruments and the position of the sound source.

Besides, Japanese Patent Application Publication No. 2013-15468 (JP 2013-15468 A) discloses an art of extracting an abnormal region through the use of a sound collecting device to which a plurality of microphones are attached at equal intervals. In JP 2013-15468 A, a plurality of virtual screens are virtually set, the virtual screens are distributed on a lattice plane, and a sound pressure level at each of a plurality of lattice points is computed by subjecting a sound pressure signal obtained from the sound collecting device to beam forming processing. Then, a sound pressure abnormal region is extracted from the lattice points by comparing the sound pressure level and a reference sound pressure level with each other.

### SUMMARY

In monitoring an instrument based on a sound, there have been demands for the immediacy of making a determination on abnormality. That is, there have been demands for the act of monitoring on a more real-time basis by shortening the processing time from acquisition of the sound to the determination on abnormality. Besides, there have also been demands for the simplification of a monitoring apparatus.

An apparatus according to JP 2017-32488 A associates coordinate positions of the sound collecting elements with instrument units respectively, and specifies the position of the sound source producing the abnormal sound based on the positions of the sound collecting elements. Therefore, as the number of instrument units to be diagnosed increases, the number of required sound collecting elements increases as well. Therefore, the apparatus according to JP 2017-32488 A cannot meet the demands for the simplification of the monitoring apparatus.

An apparatus according to JP 2013-15468 A extracts the abnormal region based on the sound pressure level calculated for each of the lattice points where the virtual screens are distributed respectively. Therefore, the sound pressure level needs to be calculated and the determination on abnormality needs to be made as many times as the number of lattice points, so the amount of computation is large. In consequence, the apparatus according to JP 2013-15468 A makes the processing time from acquisition of the sound to the determination on abnormality long, and cannot meet the demands for the immediacy of making the determination on abnormality. In particular, in the case where the scope of the abnormal region is narrowed to carry out monitoring in more detail, the number of lattice points needs to be increased, which leads to a further deterioration in the immediacy of making the determination on abnormality.

Thus, the disclosure relates to a monitoring apparatus and a monitoring method for monitoring a target region based on a sound wave, and provides a monitoring apparatus and a monitoring method that enable monitoring on a more real-time basis while restraining the configuration of the apparatus from becoming complicated.

A monitoring apparatus according to a first aspect of the disclosure monitors a plurality of target regions. The monitoring apparatus includes a sound collecting device and an information processing device. The sound collecting device has a plurality of microphones arranged. The microphones convert sound waves emitted from the target regions into sound pressure signals respectively. The information processing device is configured to store map information on positions of the target regions with respect to the sound collecting device, and is configured to extract a specific sound pressure signal from the sound pressure signals for each of the target regions by subjecting the sound pressure signals to beam forming processing based on the map information.

According to the foregoing aspect, even in the case where the number of target regions to be monitored increases, when the number of target regions included in the map information is increased, the additional target regions can be added to the target regions to be monitored. Therefore, there is no need to add any more sound collecting devices as the number of target regions increases, so the monitoring apparatus can be restrained from becoming complicated. Besides, the monitoring apparatus of the disclosure performs the beam forming processing based on the map information, and hence can limit the regions to be subjected to the beam forming processing to the regions to be monitored (the regions to be subjected to the detection of abnormality). Therefore, the processing time required for the beam forming processing can be shortened. Thus, monitoring can be carried out on a more real-time basis.

In the foregoing aspect, the information processing device may be configured to perform the beam forming processing with a direction of beam forming fixed to a direction from each of the target regions determined based on the map information toward the sound collecting device. Thus, the number of directions in which the beam forming process is performed can be narrowed down to the number of target regions where an abnormality is estimated to occur. As a result, the amount of arithmetic operation of the beam forming processing can be reduced.

In the foregoing aspect, the information processing device may be configured to store a reference signal for each of the target regions, and the information processing device may be configured to detect an abnormality in each of the target regions based on a comparison between the specific sound pressure signal and the reference signal to which the specific sound pressure signal and each of the target regions correspond. Thus, an abnormality can be more accurately detected for each of the target regions.

A monitoring method according to a second aspect of the disclosure is designed to monitor a plurality of target regions by a sound collecting device having a plurality of microphones arranged. The monitoring method includes acquiring map information on positions of the target regions with respect to the sound collecting device, acquiring a synthetic sound wave obtained by synthesizing sound waves emitted from the target regions, in a state of being converted into sound pressure signals by the microphones respectively, and extracting a specific sound pressure signal from the sound pressure signals for each of the target regions, by subjecting the sound pressure signals to beam forming processing based on the map information.

According to the foregoing aspect, even in the case where the number of target regions to be monitored increases, when the number of target regions included in the map information is increased, the additional target regions can be added to the target regions to be monitored. Therefore, there is no need to add any more sound collecting devices as the number of target regions increases, so a configuration needed to carry out the monitoring method can be restrained from becoming complicated. Besides, the monitoring method of the disclosure includes the performance of the beam forming processing based on the map information, and hence can limit the regions to be subjected to the beam forming processing to the regions to be monitored (the regions to be subjected to the detection of abnormality). Therefore, the processing time required for the beam forming processing can be shortened. Thus, monitoring can be carried out on a more real-time basis.

The foregoing first and second aspects relate to the monitoring apparatus and the monitoring method for monitoring the target regions based on the sound waves, and can enable monitoring on a more real-time basis while restraining the configuration of the apparatus from becoming complicated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a monitoring apparatus according to one of the embodiments;

FIG. 2 is a table showing an example of map information according to the embodiment;

FIG. 3 is an XY-plane showing the example of map information according to the embodiment;

FIG. 4 is a flowchart showing a procedure of monitoring processing according to the embodiment; and

FIG. 5 is a flowchart showing the details of an abnormality detection process of FIG. 4.

### DETAILED DESCRIPTION OF EMBODIMENTS

### Embodiments

One of the embodiments of the disclosure will be described hereinafter with reference to the drawings.

In the present disclosure, the term “sound wave” means an elastic wave propagating in a medium (e.g., a gas, a liquid, or a solid). The sound wave includes an ultrasonic wave (equal to or higher than 20 kHz) and an infrasonic wave (lower than 20 Hz) as well as “a sound” of audible frequencies for humans (equal to or higher than 20 Hz and lower than 20 kHz).

Configuration of Monitoring Apparatus

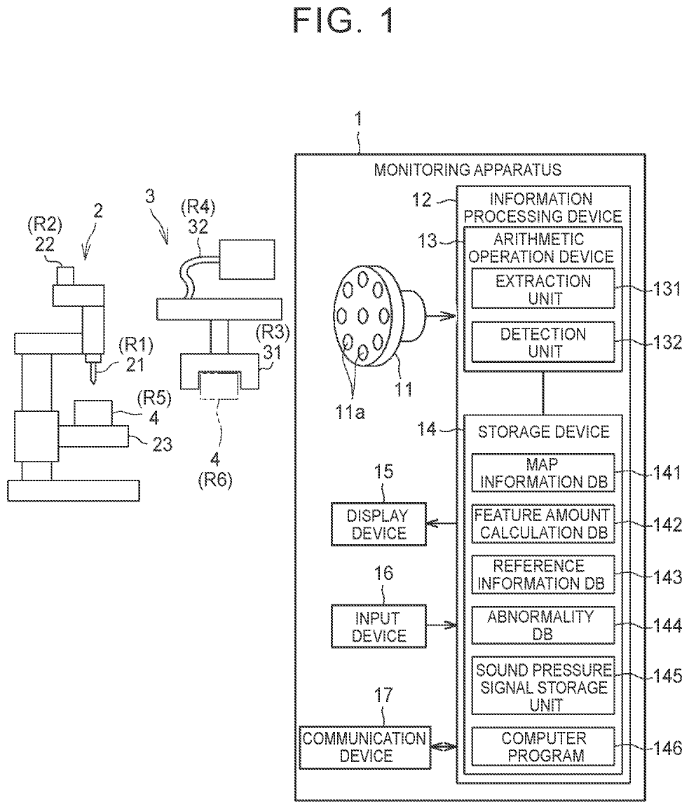

FIG. 1 is a schematic view showing a monitoring apparatus 1 according to the embodiment. The monitoring apparatus 1 is an apparatus that monitors a plurality of target regions based on sound waves. The monitoring apparatus 1 is installed in, for example, a place where an object to be worked (a work) is worked.

The target regions of the present embodiment include target regions R1 to R4 where parts (components) in which a device abnormality is estimated to occur, and target regions R5 and R6 where a work processed by the device is located. The target regions R1 to R6 will be referred to hereinafter simply as “target regions R” when the target regions are not distinguished from one another in particular.

In the present embodiment, as shown in FIG. 1, a tool 21 (e.g., a drill) included in a machining device 2 is located in the target region R1, and a motor 22 included in the machining device 2 is located in the target region R2. By the same token, an arm 31 included in a transfer device 3 is located in the target region R3, and a tube 32 for delivering compressed air to an actuator of the transfer device 3 from a compressor is located in the target region R4. Besides, a work 4 placed on a working platform 23 of the machining device 2 is located in the target region R5 (a region of the work 4 indicated by a solid line in FIG. 1), and the work 4 transferred by the arm 31 is located in the target region R6 (a region of the work 4 indicated by a broken line in FIG. 1).

The monitoring apparatus 1 is equipped with a sound collecting device 11, an information processing device 12, a display device 15, an input device 16, and a communication device 17. The sound collecting device 11 has a plurality of microphones 11a arranged on a plane. That is, the sound collecting device 11 is a microphone array (a planar array). The microphones 11a are sound pressure sensors that convert a synthetic sound wave SW2 obtained by synthesizing sound waves SW1 emitted from the target regions R into sound pressure signals SP1 respectively. The microphones 11a are, for example, omnidirectional microphones. In FIG. 1, for instance, the nine microphones 11a are arranged in the sound collecting device 11, but the number of microphones 11a arranged is not limited thereto.

The sound collecting device 11 is installed at a position spaced apart from the target regions R by a certain distance. For example, the sound collecting device 11 is installed at a position spaced apart from the target regions R by several tens of centimeters to several meters, while facing the target regions R, respectively. The sound collecting device 11 is thus installed at a position spaced apart from the target regions R by predetermined distances respectively, so the synthetic sound wave SW2 obtained by synthesizing the sound waves SW1 emitted from the target regions R as well as the sound wave SW1 emitted from a certain one of the target regions R can be acquired.

The information processing device 12 has an arithmetic operation device 13 and a storage device 14. The information processing device 12 is, for example, a computer device. The storage device 14 is a device that stores various pieces of information, and is a device having, for example, a hard disk drive (HDD), a random access memory (RAM), and a read only memory (ROM).

From a functional point of view, the storage device 14 has a map information database 141, a feature amount calculation database 142, a reference information database 143, an abnormality database 144, and a sound pressure signal storage unit 145. Respective portions (141, 142, 143, 144, and 145) of the storage device 14 are constituted by predetermined storage regions in the storage device 14 respectively. Incidentally, the respective portions (141, 142, 143, 144, and 145) may be constituted by the same storage region, or may be constituted by storage regions that are different from one another. The storage device 14 further stores a computer program 146.

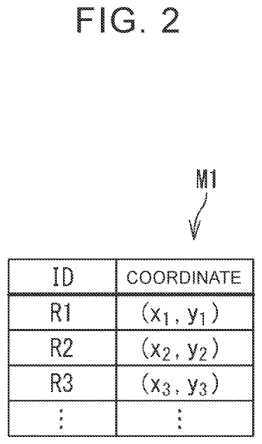

Map information M1 is stored in the map information database 141. The map information M1 is a piece of information on positions of the target regions R with respect to the sound collecting device 11. For example, the map information M1 is stored as a piece of table-type information including ID's of the target regions R and coordinates of the target regions R as shown in FIG. 2. As the coordinates of the target regions R, only central coordinates of the target regions R may be stored, or coordinates of several points may be stored in such a manner as to follow contours of the target regions R.

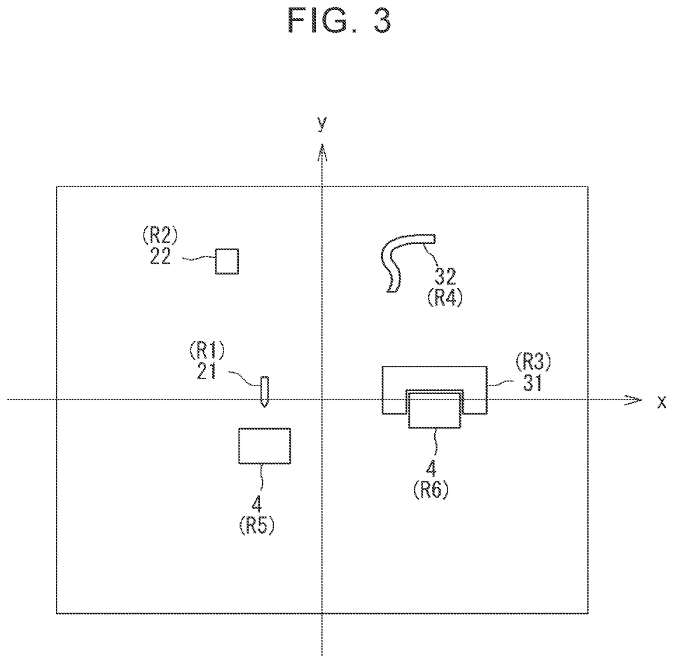

FIG. 3 is a schematic view showing an example of the map information M1 on a predetermined XY-plane. The XY-plane is a plane parallel to a plane (an array plane) on which the microphones 11a of the sound collecting device 11 are arranged. In other words, FIG. 3 shows the positions of the target regions R that are projected onto the predetermined XY-plane when the target regions R are viewed from the sound collecting device 11 in the direction of a normal of the array plane. In FIG. 3, the center of the sound collecting device 11 is an origin, and each of the contours of the target regions R with respect to the sound collecting device 11 is indicated by a coordinate (x, y).

The map information database 141 may store a plurality of pieces of map information M1. For example, the map information database 141 may store map information M1a including ID's and coordinates of the target regions R1, R2, R4, and R5 and map information M1b including ID's and coordinates of the target regions R3, R4, and R6.

Processing information F1 for calculating a feature amount is stored in the feature amount calculation database 142. “The feature amount” is a piece of information used to make a determination on abnormality in the target regions R, and is calculated by subjecting a later-described specific sound pressure signal SP2 to predetermined signal processing. The processing information F1 is a piece of information on the contents of the signal processing, and is, for example, a piece of information on a function using the specific sound pressure signal SP2 as a variable. When the specific sound pressure signal SP2 is subjected to the signal processing based on the processing information F1, a single or a plurality of feature amounts are calculated. The feature amount or the feature amounts will be referred to hereinafter as “a feature set FS1”. For example, the processing information F1 is stored as a piece of table-type information including ID's of the target regions R and a single or a plurality of functions on the signal processing of the target regions R.

Reference information N1 for making a determination on abnormality is stored in the reference information database 143. The reference information N1 includes a reference signal RF1 on the later-described specific sound pressure signal SP2 at the time of normal operation of the target regions R, and a threshold TH1 for making a determination on abnormality. The reference information N1 is prepared for each of the target regions R.

Abnormality information E1 is stored in the abnormality database 144. The abnormality information E1 is a piece of information on the cause and type of an abnormality. In more concrete terms, the abnormality information E1 is, for example, a piece of table-type information including a sound pressure signal acquired by the sound collecting device 11 in the past and determined as abnormal, and an abnormality cause (or an abnormality type) corresponding to the sound pressure signal.

The sound pressure signals SP1 acquired by the sound collecting device 11, the specific sound pressure signal SP2 calculated by the arithmetic operation device 13, and the feature set FS1 are stored in the sound pressure signal storage unit 145.

The arithmetic operation device 13 is a device that retrieves the computer program 146 from the storage device 14 and that performs various arithmetic operations, and is, for example, a central processing unit (CPU). The arithmetic operation device 13 realizes the function of an extraction unit 131 and the function of a detection unit 132 by executing the computer program 146 stored in the storage device 14.

The extraction unit 131 extracts the specific sound pressure signal SP2 from the sound pressure signals SP1 for each of the target regions R, by subjecting the sound pressure signals SP1 to beam forming processing based on the map information M1. The detection unit 132 calculates the feature set FS1 by subjecting the specific sound pressure signal SP2 to signal processing based on the processing information F1, and makes a determination on abnormality based on the feature set FS1 and the reference information N1. The concrete functions of the extraction unit 131 and the detection unit 132 will be described later.

The display device 15 is electrically connected to the information processing device 12, and displays monitoring information on the target regions R to a user. The display device 15 is, for example, a display and a speaker. The monitoring information includes, for example, a piece of information on an abnormality determination result obtained by the detection unit 132 and an abnormality cause. The input device 16 is electrically connected to the information processing device 12, and transmits the information input from the user to the information processing device 12. The input device 16 is, for example, a mouse and a keyboard.

The communication device 17 is electrically connected to the information processing device 12, and transmits/receives various pieces of information to/from an external device (not shown) (e.g., a management device for managing a plurality of monitoring apparatuses 1). For example, the communication device 17 transmits monitoring information on the target regions R to the management device, and receives the map information M1, the processing information F1, the reference information N1, and the abnormality information E1 from the management device.

Procedure of Monitoring Process

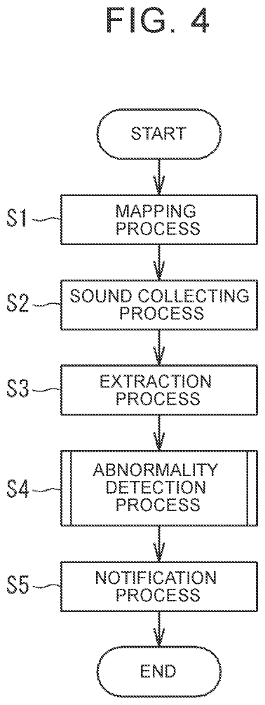

FIG. 4 is a flowchart showing the procedure of monitoring processing according to the embodiment. When the user of the monitoring apparatus 1 commands the monitoring apparatus 1 to perform monitoring processing through the use of the input device 16, the monitoring apparatus 1 starts the monitoring processing.

When the monitoring processing is started, a mapping process S1 is first performed. The mapping process S1 is a process of acquiring the map information M1. The sound collecting device 11, the machining device 2, and the transfer device 3 are installed at predetermined positions in a factory, respectively. Besides, a position at which the work 4 is worked by the machining device 2, and a position to which the work 4 is transferred by the transfer device 3 are determined in advance. Therefore, relative positions of the sound collecting device 11 and the target regions R are uniquely determined.

For example, the map information M1 is acquired through the inputting of positional information on the target regions R with respect to the sound collecting device 11 to the input device 16 by the user. Alternatively, the map information M1 may be acquired by being received from the management device via the communication device 17. The acquired map information M1 is stored into the map information database 141. The mapping process S1 is thus ended.

Subsequently, a sound collecting process S2 is performed. The sound collecting process S2 is performed while the machining device 2 shown in FIG. 1 and the transfer device 3 shown in FIG. 1 are in operation and the work 4 is worked or transferred. That is, during the sound collecting process S2, the target regions R generate the sound waves SW1 respectively, and the synthetic sound wave SW2 obtained by synthesizing the sound waves SW1 propagates to the sound collecting device 11.

When the sound collecting process S2 is started, the microphones 11a included in the sound collecting device 11 convert the input synthetic sound waves SW2 into the sound pressure signals SP1 respectively, and output the sound pressure signals SP1 to the information processing device 12 respectively. The sound pressure signals SP1 acquired by the microphones 11a respectively are stored into the sound pressure signal storage unit 145. The microphones 11a are arranged at different positions on a predetermined plane respectively. Therefore, by acquiring the sound pressure signals SP1 for the microphones 11a respectively, a distribution of the sound pressure signals SP1 can be obtained. The sound collecting process S2 is thus ended.

Subsequently, an extraction process S3 is performed. The extraction process S3 is a process of extracting the specific sound pressure signal SP2 from the sound pressure signals SP1 for each of the target regions R, through subjection of the sound pressure signals SP1 to the beam forming processing by the extraction unit 131 based on the map information M1. When the extraction process S3 is started, the beam forming processing is performed a plurality of times.

For example, the specific sound pressure signal SP2 on the sound waves SW1 coming from the directions of the target regions R is extracted from the sound pressure signals SP1, by subjecting the sound pressure signals SP1 to the beam forming processing based on positional information on the target regions R1 included in the map information M1. By the same token, the specific sound pressure signal SP2 is extracted for each of the target regions R2 to R6. In the case where there are six target regions R, the number of specific sound pressure signals SP2 extracted is also six.

Besides, in the extraction process S3, the beam forming processing may be performed through the use of the map information M1 that differs depending on each process of the machining device 2 and the transfer device 3. For example, a case of performing a working process in which the tool 21 of the machining device 2 drills a hole through the work 4, and a transfer process in which the arm 31 of the transfer device 3 transfers the work 4 from the working platform 23 to another place will be considered. At this time, it is assumed that the transfer device 3 stands by without transferring the work 4 during the working process, and that the machining device 2 stands by without working the work 4 during the transfer process. In this case, it is important to monitor the machining device 2 in the working process, and it is important to monitor the transfer device 3 in the transfer process.

Therefore, the sound pressure signals SP1 obtained during the working process are subjected to the beam forming processing based on the map information M1a (information on the target regions R1, R2, R4, and R5). Since there are four target regions R, the beam forming processing is performed for each of four directions to calculate the specific sound pressure signal SP2. Besides, the sound pressure signals SP1 obtained during the transfer process are subjected to the beam forming processing for three directions respectively based on the map information M1b (information on the target regions R3, R4, and R6).

That is, in the extraction process S3, the beam forming processing is performed with the direction of beam forming fixed to a direction from each of the target regions R determined based on the map information M1 toward the sound collecting device 11. Therefore, the number of directions in which the beam forming processing is performed can be narrowed down to the number of target regions R where an abnormality is estimated to occur. As a result, the amount of arithmetic operation of the beam forming processing can be reduced.

Besides, the amount of arithmetic operation of the beam forming processing can be reduced by performing the beam forming processing based on the pieces of map information M1a and M1b that are made different from each other in the target regions R where an abnormality is estimated to occur, for each of the processes. Thus, the processing time required for the arithmetic operation can be shortened, and monitoring can be carried out on a more real-time basis.

It should be noted herein that the target region R4 is a region for monitoring the tube 32 of the compressor. “Air leakage” can be mentioned as an abnormality in the tube 32. The leakage of air from the tube 32 can take place anytime, regardless of the operation of the arm 31 of the transfer device 3. Therefore, the target region R4 may always be monitored in each of the processes as described above. The extraction process S3 is thus ended.

Subsequently, an abnormality detection process S4 is performed. The abnormality detection process S4 is a process in which the detection unit 132 detects abnormalities in the target regions R based on the specific sound pressure signal SP2, the processing information F1, and the reference information N1.

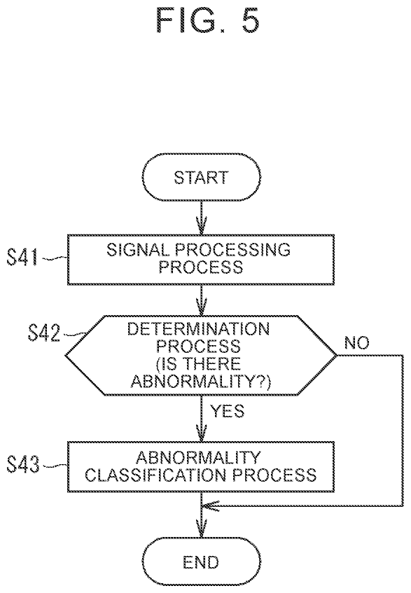

FIG. 5 is a flowchart showing the details of the abnormality detection process S4. When the abnormality detection process S4 is started, the feature set FS1 is acquired by subjecting the specific sound pressure signal SP2 to signal processing based on the processing information F1 (a signal processing process S41).

For example, the specific sound pressure signal SP2 about the target region R1 includes all the pieces of information on the sound waves SW1 coming from the direction of the target region R1. The target region R1 is a region for monitoring the tool 21, and an abnormality in the tool 21 appears especially as a difference in frequency or intensity of the turning sound of the tool 21. Therefore, with a view to determining whether or not there is an abnormality in the tool 21, the specific sound pressure signal SP2 obtained from the target region R1 is subjected to signal processing based on the processing information F1, and the feature set FS1 (i.e., the feature amount or the feature amounts) is acquired. For example, Fast Fourier transformation, filtering processing, or calculation of an average sound pressure is carried out as the signal processing. The feature amounts are, for example, a frequency distribution and an average sound pressure.

Subsequently, it is determined, based on the reference information N1, whether or not there is an abnormality in each of the target regions R (a determination process S42). For example, a difference between the feature set FS1 of the target region R1 and the reference signal RF1 of the target region R1 is calculated, and it is determined that there is no abnormality in the target region R1 when the difference is equal to or smaller than a threshold TH1 of the target region R1 (NO in the determination process S42). Besides, it is determined that there is an abnormality in the target region R1 when the difference is larger than the threshold TH1 of the target region R1 (YES in the determination process S42).

By the same token, a determination on abnormality is made as to the other target regions R2 to R6 as well. It is appropriate to adopt a configuration in which the work 4 is regarded as poor in quality and removed from a manufacturing line or the like especially when it is determined that there is an abnormality in the target region R5 in which the work 4 is worked. That is, the determination on abnormality of the present embodiment may be utilized not only to monitor an abnormality in the device, but also to control the quality of the work 4.

The reference signal RF1 of the target region R1 is the feature set FS1 obtained by subjecting the synthetic sound wave SW2 including the sound waves SW1 of the tool 21 in normal operation to the processes S2, S3, and S41. In the case where the feature set FS1 of the target region R1 includes a plurality of feature amounts, the reference signal RF1 of the target region R1 also includes a plurality of reference amounts (feature amounts at the time of normal operation). Then, a comparison is made between the feature amounts and the reference amounts that correspond to each other respectively.

That is, the reference signal RF1 is prepared for each of the target regions R, and an abnormality in each of the target regions R is detected based on a comparison between the specific sound pressure signal SP2 and the reference signal RF1 to which the specific sound pressure signal SP2 and each of the target regions R correspond. Therefore, an abnormality can be more accurately detected in each of the target regions R.

When it is determined in the determination process S42 that there is an abnormality in the target region R, the abnormality is classified (an abnormality classification process S43). For example, a comparison is made between the feature set FS1 in the target region R and pieces of the abnormality information E1 stored in the abnormality database 144. When any one of the pieces of the abnormality information E1 coincides with the feature set FS1, it is determined that the abnormality in the target region R is an abnormality based on that piece of the abnormality information E1. When none of the pieces of the abnormality information E1 coincides with the feature set FS1, it is determined that there is an unknown abnormality. The detection unit 132 adds a piece of information on the corresponding one of the pieces of the abnormality information E1 (e.g., a piece of information on a cause of the abnormality) to the feature set FS1, and stores the added result into the sound pressure signal storage unit 145. The abnormality detection process S4 is thus ended.

Subsequently, a notification process S5 is performed. When the notification process S5 is started, the information processing device 12 outputs a piece of monitoring information on each of the target regions R to the display device 15, based on the pieces of information on an abnormality determination result and an abnormality cause stored in the sound pressure signal storage unit 145. Besides, the information processing device 12 may output the piece of monitoring information to the management device via the communication device 17. Besides, when it is determined that there is an abnormality in a certain one of the target regions R, a warning sound may be issued from the speaker of the display device 15. The notification process S5 is thus ended.

As described above, the monitoring apparatus 1 of the present embodiment is equipped with the sound collecting device 11, the storage device 14, and the arithmetic operation device 13. The sound collecting device 11 has the microphones 11a arranged. The microphones 11a convert the synthetic sound wave SW2 obtained by synthesizing the sound waves SW1 emitted from the target regions R into the sound pressure signals SP1 respectively. The storage device 14 stores the map information M1 on the positions of the target regions R with respect to the sound collecting device 11 respectively. The arithmetic operation device 13 extracts the specific sound pressure signal SP2 from the sound pressure signals SP1 for each of the target regions R, by subjecting the sound pressure signals SP1 to the beam forming processing based on the map information M1.

The monitoring apparatus 1 can monitor the target regions R with the aid of the sound collecting device 11. The sound collecting device 11 is installed at one location instead of being installed differently depending on each of the target regions R. Therefore, the facilities such as wirings for providing the sound collecting device 11 can be restrained from becoming complicated. Besides, even in the case where the number of target regions R to be monitored in a predetermined space increases, when the number of target regions R included in the map information M1 is increased, the additional target regions R can be added to the target regions R to be monitored. Therefore, there is no need to add any more sound collecting devices 11, so the monitoring apparatus 1 can be restrained from becoming complicated.

Furthermore, the monitoring apparatus 1 performs the beam forming processing based on the map information M1, and hence can limit the regions to be subjected to the beam forming processing to the regions to be monitored (the regions to be subjected to the detection of abnormality). Therefore, the processing time required for the beam forming processing can be shortened, and the time taken from acquisition of the sound pressure signal SP1 to extraction of the specific sound pressure signal SP2 and a determination on abnormality can also be shortened. Thus, monitoring can be carried out on a more real-time basis.

### Modification Example

While the embodiment of the disclosure has been described above, the disclosure can be subjected to various alterations other than the above-mentioned embodiment. A modification example according to the embodiment of the disclosure will be described hereinafter. In the following modification example, components identical to those of the embodiment are denoted by the same reference symbols respectively, and the description thereof will be omitted.

In the above-mentioned embodiment, the feature set FS1 is calculated in the signal processing process S41, and the feature amount included in the feature set FS1 and the reference amount included in the reference information N1 are compared with each other in the determination process S42. However, the signal processing process S41 may be omitted, and the specific sound pressure signal SP2 acquired in the extraction process S3 and the reference amount included in the reference information N1 may be directly compared with each other in the determination process S42.

### OTHERS

The embodiment disclosed above is exemplary and nonrestrictive in all respects. That is, the monitoring apparatus of the disclosure is not limited to the illustrated embodiment, but may be realized as other embodiments within the scope of the disclosure.

What is claimed is:

1. A monitoring apparatus that monitors a plurality of target regions, the monitoring apparatus comprising:
a sound collecting device having a plurality of microphones arranged, the microphones converting sound waves emitted from the target regions into sound pressure signals respectively; and
an information processing device configured to store map information on positions of the target regions with respect to the sound collecting device, and configured to extract a specific sound pressure signal from the sound pressure signals for each of the target regions by subjecting the sound pressure signals to beam forming processing based on the map information.

2. The monitoring apparatus according to claim 1, wherein
the information processing device is configured to perform the beam forming processing with a direction of beam forming fixed to a direction from each of the target regions determined based on the map information toward the sound collecting device.

3. The monitoring apparatus according to claim 1, wherein
the information processing device is configured to store a reference signal for each of the target regions, and
the information processing device is configured to detect an abnormality in each of the target regions based on a comparison between the specific sound pressure signal and the reference signal to which the specific sound pressure signal and each of the target regions correspond.

4. A monitoring method for monitoring a plurality of target regions by a sound collecting device having a plurality of microphones arranged, the monitoring method comprising:
acquiring map information on positions of the target regions with respect to the sound collecting device;
acquiring a synthetic sound wave obtained by synthesizing sound waves emitted from the target regions, in a state of being converted into sound pressure signals by the microphones respectively; and
extracting a specific sound pressure signal from the sound pressure signals for each of the target regions, by subjecting the sound pressure signals to beam forming processing based on the map information.
